(19) United States
(12) Patent Application Publication
(10) Pub. No.: US 2012/0088650 A1
(43) Pub. Date: Apr. 12, 2012

(54) MANUFACTURING METHOD FOR CATALYST CARRIER

(75) Inventors: Yuichiro Hama, Nagoya-shi (JP); Masaru Hori, Nagoya-shi (JP); Hiroyuki Kano, Miyoshi-shi (JP)

(73) Assignees: NATIONAL UNIVERSITY CORPORATION NAGOYA UNIVERSITY, Nagoya-shi (JP); TOYOTA JIDOSHA KABUSHIKI KAISHA, Toyota-shi (JP)

(21) Appl. No.: 13/247,165

(22) Filed: Sep. 28, 2011

(30) Foreign Application Priority Data
Oct. 5, 2010 (JP) 2010-225359

(51) Int. Cl. B01J 37/08; B01J 21/18; B82Y 30/00

(52) U.S. Cl. 502/1; 977/902

(57) ABSTRACT

After placing inside a reactor second container a substrate to which a CNT not yet carrying a catalyst is adhered under a sealed environment of supercritical carbon dioxide through which a Pt catalyst complex is dispersed, a temperature of the supercritical carbon dioxide is maintained below a decomposition temperature of the Pt catalyst complex, and a temperature of the CNT not yet carrying a catalyst is maintained at or above the decomposition temperature of the Pt catalyst complex by heating the substrate. Further, a pressure of the supercritical carbon dioxide is maintained at 7.5 MPa, which is slightly higher than a supercritical pressure (7.38 MPa) of carbon dioxide. The supercritical carbon dioxide is then caused to contact the CNT adhered to the substrate, and as a result, a Pt catalyst is carried on the CNT.

### INCORPORATION BY REFERENCE

The disclosure of Japanese Patent Application No. 2010-225359, filed on Oct. 5, 2010 including the specification, drawings and abstract, is incorporated herein by reference in its entirety.

### BACKGROUND OF THE INVENTION

1. Field of the Invention

The invention relates to a manufacturing method for a conductive catalyst carrier.

2. Description of Related Art

An MEA (Membrane-Electrode Assembly), in which an electrode catalyst layer is joined to respective surfaces of an electrolyte membrane, may be employed in a fuel cell. The electrode catalyst layer includes a conductive catalyst carrier and an electrolyte resin. An electrode reaction occurs via a catalyst on a so-called three-phase interface where a gas flow passage, the electrolyte resin, and the catalyst carrier come into contact. Therefore, the catalyst is preferably provided on the three-phase interface, and accordingly, a method is required to ensure that the catalyst is not carried on the catalyst carrier eccentrically.

In recent years, carbon nanotubes (to be referred to hereafter as “CNTs”) have gained attention as a conductive carrier due to a perpendicular alignment property thereof, establishment of formation methods thereof, and so on, and accordingly, CNTs are being used more often in electrode catalyst layers for MEAs in place of particles such as carbon black. Various methods have been proposed to suppress eccentricity during catalyst carrying on a CNT (see Japanese Patent Application Publication No. 2006-273613 (JP-A-2006-273613), for example). In this method, a catalyst dispersed through a supercritical fluid is carried on a CNT carrier, and therefore a CNT carrier carrying a catalyst non-eccentrically can be provided.

Incidentally, although conventionally in order to set a fluid in a supercritical condition, a temperature and a pressure thereof must be regulated in accordance with properties of the fluid, there remains room for improvement in the use of a supercritical fluid as a catalyst carrier. Note that this problem is not limited to a case in which a CNT is used as the carrier, and occurs likewise when a catalyst is carried on a particulate carrier such as carbon black or the like as the carrier.

### SUMMARY OF THE INVENTION

The invention increases the effectiveness of catalyst carrying using a supercritical fluid such as that described above.

An inventor of this application arrived at the invention by discovering that catalyst carrying is dependent on a sealed environment of the supercritical fluid.

A first aspect of the invention relates to a manufacturing method for a conductive catalyst carrier. This manufacturing method includes: placing a substrate to which a carrier is adhered in a sealed environment of a supercritical fluid through which a catalyst complex is dispersed, and maintaining a temperature of the supercritical fluid below a decomposition temperature of the catalyst complex; maintaining a temperature of the carrier at or above the decomposition temperature of the catalyst complex by heating the substrate; maintaining a pressure of the supercritical fluid within a range extending from a supercritical pressure of a fluid used as the supercritical fluid to a pressure at least 1% higher than the supercritical pressure; and causing the supercritical fluid to contact the carrier so that a catalyst is carried on the carrier.

In the manufacturing method for a catalyst carrier described above, the catalyst complex is dispersed through the supercritical fluid without decomposing by placing the substrate to which the carrier is adhered in the sealed environment of the supercritical fluid and maintaining the temperature of the supercritical fluid in the sealed environment below the decomposition temperature of the catalyst complex. Further, the temperature of the carrier adhered to the substrate is maintained at or above the decomposition temperature of the catalyst complex by heating the substrate, and therefore the catalyst complex dispersed through the supercritical fluid contacting the carrier decomposes on the surface of the carrier. In this case, the temperature of the carrier is dependent on the temperature of the heated substrate, and therefore the temperature of the carrier can be maintained by maintaining the temperature of the substrate. By performing temperature maintenance in this manner, the catalyst is deposited onto the carrier and carried on a surface of the carrier, and therefore a condition in which the catalyst carrier carrying the catalyst is adhered to the substrate can be obtained. Although the catalyst is thus carried on the carrier, catalyst carrying is dependent on the pressure of the supercritical fluid (the supercritical fluid pressure hereafter) in the sealed environment, and therefore, in a range where the supercritical fluid pressure is lower than the supercritical pressure of the fluid used as the supercritical fluid, dispersion of the catalyst complex does not advance. As a result, the catalyst is not carried on the carrier efficiently.

However, the inventor of this application has newly discovered that when the supercritical fluid pressure is within a pressure range at least 1% higher than the supercritical pressure, catalyst carrying on the carrier is dependent on the supercritical fluid pressure. Firstly, the inventor discovered that when the supercritical fluid pressure is in the vicinity of the supercritical pressure of the fluid but at least 1% higher than this pressure (the supercritical pressure), dispersion of the catalyst complex advances rapidly such that catalyst carrying is achieved favorably. Further, the inventor newly discovered that as long as the supercritical fluid pressure remains within a range extending from a pressure at least 1% higher than the supercritical pressure to a pressure approximately 40% higher than this pressure (the supercritical pressure), for example, catalyst carrying on the carrier still occurs beneficially in practical terms, though the carrying speed is comparatively sluggish. Therefore, by maintaining the supercritical fluid pressure within a range extending from the supercritical pressure of the fluid to a pressure at least 1% higher than the supercritical pressure, an effectiveness with which the catalyst is carried on the carrier can be improved. More specifically, catalyst carrying can be performed in a short amount of time, leading to an improvement in the manufacturing efficiency of the catalyst carrier carrying the catalyst and a corresponding reduction in cost. In this case, an upper limit (40%, for example, as noted above) of the supercritical fluid pressure maintenance range may be determined through experiment at a pressure where the phenomenon of comparatively sluggish catalyst carrying speed on the carrier occurs, taking into account the types, properties, and so on of the supercritical fluid and the catalyst complex.

The manufacturing method for a catalyst carrier described above may be provided in a following embodiment. For example, the carrier may be a perpendicularly aligned material formed substantially perpendicularly on the substrate, such as a perpendicularly aligned CNT, for example. Thus, a catalyst carrier carrying a catalyst deposited around the perpendicularly aligned material, or in other words a catalyst carrier formed from a perpendicularly aligned CNT serving as the perpendicularly aligned material can be adhered to the substrate.

Note that the invention may be realized in various embodiments. For example, to apply the invention to a manufacturing method for an electrode catalyst layer having a catalyst carrier, the substrate to which the catalyst carrier obtained in the manner described above is adhered may be subjected to processing for covering the catalyst carrier with electrolyte resin such that the catalyst carrier is covered in the electrolyte resin while adhered to the substrate. In so doing, an electrode catalyst layer is formed on the substrate. Further, to apply the invention to a manufacturing method for a MEA in which electrode catalyst layers are joined to respective membrane surfaces of an electrolyte membrane, the electrode catalyst layer formed on the surface of the substrate in the manner described above may be transferred onto the membrane surfaces of the electrolyte membrane. Furthermore, to apply the invention to a manufacturing method for a fuel cell, a reaction gas flow passage forming member forming a flow passage for reaction gas used in an electrochemical reaction on the electrode catalyst layer may be disposed on respective surfaces of the electrolyte membrane onto which the electrode catalyst layer formed on the substrate surface has been transferred. The invention may also be realized in embodiments such as a fuel cell system including a fuel cell and a vehicle installed with a fuel cell system.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic sectional view showing a sectional constitution of a fuel cell 100 serving as an embodiment of the invention;

FIG. 2 is an enlarged sectional view showing an enlargement of an X1 portion in FIG. 1;

FIG. 3 is a schematic view showing a manufacturing apparatus for an electrode catalyst layer 10;

FIG. 4 is a process diagram showing an overall flow of a process for manufacturing the electrode catalyst layer;

FIG. 5 is a process diagram showing a catalyst carrying process in detail;

FIGS. 6A to 6C are schematic views illustrating the catalyst carrying process;

FIG. 7 is a graph showing a relationship between a pressure and a carried particle density of platinum particles (Pt particles) in a case where a predetermined amount of a Pt complex is dispersed through supercritical carbon dioxide;

FIG. 8 is a graph showing a relationship between the pressure and the carried particle density of the Pt particles in a case where the predetermined amount of the Pt complex is dispersed through the supercritical carbon dioxide and catalyst carrying is performed for five minutes;

FIG. 9 is a graph showing a relationship between the carried particle density of the Pt particles and an amount of a Pt complex solution introduced into a reactor second container 112b;

FIG. 10 is a graph showing a relationship between a carried weight of the Pt particles and a substrate temperature defining a carrier temperature in the reactor second container 112b;

FIG. 11 is a schematic view showing a manufacturing apparatus for the electrode catalyst layer 10 according to a modified example; and

FIG. 12 is a process diagram showing a catalyst carrying process according to the modified example in detail.

### DETAILED DESCRIPTION OF EMBODIMENTS

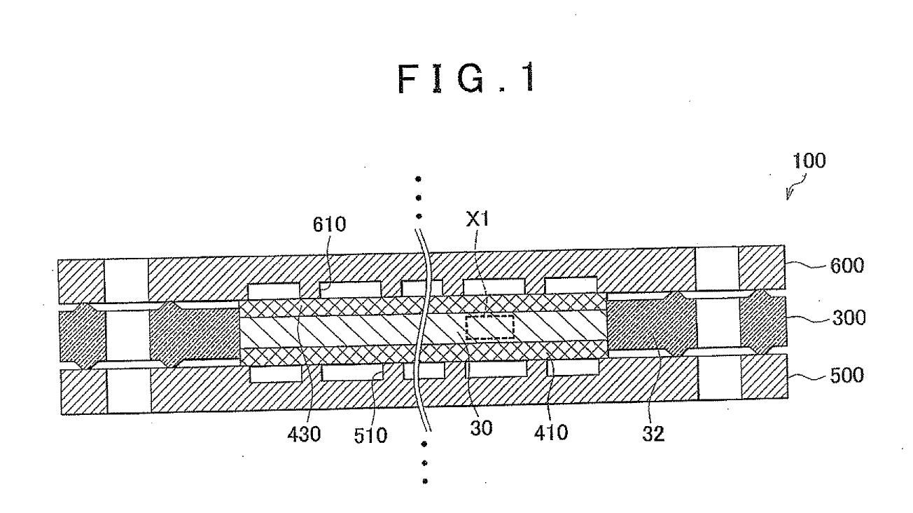

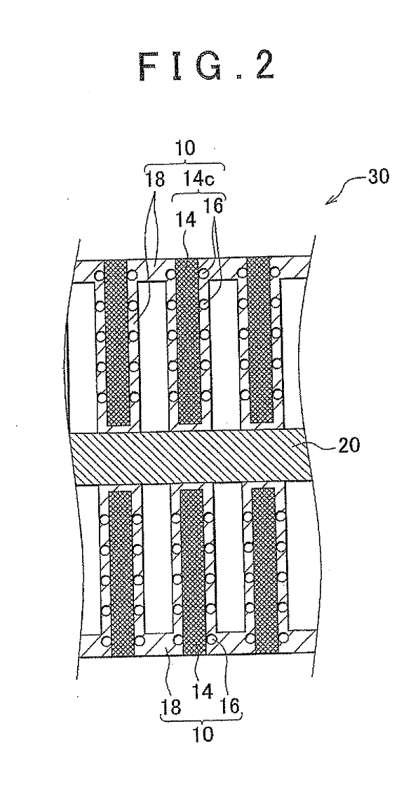

FIG. 1 is a schematic sectional view showing a sectional constitution of a fuel cell 100 serving as an embodiment of the invention, and FIG. 2 is an enlarged sectional view showing an enlargement of an X1 portion in FIG. 1. The fuel cell 100 is a polymer electrolyte fuel cell that generates power using hydrogen and air.

As shown in FIG. 1, the fuel cell 100 is formed by laminating an anode side gas diffusion layer 410 and an anode side separate 500 in sequence on an anode side of an integrated sealing member type MEA 300, and laminating a cathode side gas diffusion layer 430 and a cathode side separator 600 in sequence on a cathode side of the integrated sealing member type MEA 300. The respective gas diffusion layers form flow passages for a reaction gas used in an electrochemical reaction on an electrode catalyst layer 10. FIG. 1 shows an extracted portion of a part formed by laminating together pluralities of the integrated sealing member type MEAs 300, anode side gas diffusion layers 410, anode side separators 500, cathode side gas diffusion layers 430, and cathode side separators 600, and a remaining portion has been omitted from the drawing. The anode side separator 500 and the cathode side separator 600 will also be referred to hereafter simply as the separators 500, 600.

Note that cooling water separators (not shown) formed with a cooling water flow passages through which cooling water flows are disposed between the anode side separator 500 and the cathode side separator 600 at predetermined intervals. When cooling water is caused to flow through the interior of the cooling water separators, heat generated by an electrode reaction in the fuel cell 100 is removed, and as a result, an internal temperature of the fuel cell 100 is maintained within a predetermined range.

The fuel cell 100 is manufactured in a following process. First, the MEA 30 is manufactured by transferring the electrode catalyst layer 10, which is manufactured using an electrode catalyst layer manufacturing method to be described below, onto respective surfaces of an electrolyte membrane 20. The integrated sealing member type MEA 300 is then manufactured by forming a sealing member 32 on an outer periphery of the MEA 30. A plurality of fuel cell modules (400, for example) formed by laminating the anode side gas diffusion layer 410 and the anode side separator 500 in succession on the anode side of the integrated sealing member type MEA 300 and laminating the cathode side gas diffusion layer 430 and the cathode side separator 600 in succession on the cathode side of the integrated sealing member type MEA 300 are then laminated together. Respective constitutional members are then disposed such that a current collector (not shown), an insulating plate (not shown), and an end plate (not shown) are laminated in succession onto respective ends of the laminated fuel cell modules. The respective constitutional members of the fuel cell 100 are then fastened by a tension plate, a tension rod, and so on such that a predetermined pressing force is applied in a lamination direction, and by holding the fuel cell 100 in this laminated condition, the fuel cell 100 is completed.

A plurality of ribs 510 are formed on a surface of the anode side separator 500 opposing the anode side gas diffusion layer 410. Similarly, a plurality of bumps are provided on a surface of the cathode side separator 600 opposing the cathode side gas diffusion layer 430 to form ribs 610. The separators 500, 600 sandwich the MEA 30 from either side to form flow passages through which hydrogen serving as an anode gas and air serving as a cathode gas flow, respectively.

Air supplied to the fuel cell 100 flows into the cathode side gas diffusion layer 430 through the flow passage formed by the ribs 610 of the cathode side separator 600, and while flowing through the cathode side gas diffusion layer 430, the air is supplied to the MEA 30 for use in the electrode reaction. Similarly, hydrogen supplied to the fuel cell 100 flows into the anode side gas diffusion layer 410 through the flow passage formed by the ribs 510 of the anode side separator 500, and while flowing through the anode side gas diffusion layer 410, the hydrogen passes through the fuel cell 100 for use in the electrode reaction.

Note that in this embodiment, it is assumed that stainless steel flat plates are used as the separators 500, 600, but flat plates made of other metals such as titanium and aluminum or carbon flat plates may be used instead. Further, the shape of the separators 500, 600 is not limited to the aforesaid shape including the ribs.

Furthermore, in this embodiment, carbon felt subjected to water repellency treatment is used as the anode side gas diffusion layer 410 and cathode side gas diffusion layer 430. Note that in the constitution cited as an example in this embodiment, the anode side gas diffusion layer 410 and the cathode side gas diffusion layer 430 are disposed between the MEA 30 and the respective separators 500, 600. However, a constitution not including the anode side gas diffusion layer 410 and cathode side gas diffusion layer 430, or in other words a constitution in which the MEA 30 contacts the separators 500, 600, may be provided instead.

As shown in FIG. 2, in the MEA 30, the electrode catalyst layer 10 is laminated onto respective surfaces of the electrolyte membrane 20. In this embodiment, a polymer electrolyte membrane (a Nafion (registered trademark; likewise hereafter) membrane: NRE 212) formed from a fluorine-based sulfonic acid polymer serving as a proton-conductive polymer electrolyte material is used as the electrolyte membrane 20. Note that the polymer electrolyte membrane is not limited to Nafion (registered trademark), and another fluorine-based sulfonic acid membrane, such as Aciplex (registered trademark) or Flemion (registered trademark), for example, may be used instead. Further, a fluorine based phosphoric acid membrane, a fluorine-based carboxylic acid membrane, a fluorine hydrocarbon-based graft membrane, a hydrocarbon-based graft membrane, an aromatic membrane, and so on, for example, may be used. Furthermore, a composite polymer membrane containing a reinforcing material such as PTFE or polyamide such that a mechanical characteristic thereof is strengthened may be used.

The electrode catalyst layer 10 includes a CNT 14 serving as a conductive carrier obtained through a catalyst carrier manufacturing method according to this embodiment, and is formed by carrying Pt particles 16 serving as a catalyst on the CNT 14 and covering the CNT 14 carrying the Pt particles 16 (also referred to hereafter as a “Pt carrying CNT 14c”) with electrolyte resin 18. In this embodiment, Nafion is used as the electrolyte resin 18. Carrying of the Pt particles 16 on the CNT 14 and covering of the CNT 14 with the electrolyte resin 18 will be described below.

In this embodiment, the rectilinear CNT 14 is used as the conductive carrier, and therefore a large surface area can be secured on a carrying surface such that the catalyst (the Pt particles 16) can be carried at a high density. Further, the Pt carrying CNT 14c is covered by the electrolyte resin 18, and as shown in FIG. 2, the CNT 14 is aligned substantially perpendicularly to the electrolyte membrane 20. Reaction gas flows through gaps formed by the plurality of CNTs 14, and therefore the reaction gas is supplied favorably to the catalyst (the Pt particles 16) disposed in the vicinity of a three-phase interface. As a result, an effectiveness of the catalyst can be improved.

Further, as noted above, the CNT 14 serving as the conductive carrier according to this embodiment is aligned substantially perpendicularly to the electrolyte membrane 20. Therefore, in addition to the favorable reaction gas supply performance, a favorable discharge performance is obtained in relation to generated water generated by the electrochemical reaction. In this embodiment, a perpendicularly aligned CNT aligned substantially perpendicularly on a substrate is used, and therefore the MEA 30 is manufactured such that the CNT 14 serving as the conductive carrier is aligned substantially perpendicularly to the electrolyte membrane 20.

To form the electrode catalyst layer 10 constituting the MEA 30, a substrate 12, to be described below, is used as a base material for forming the electrode catalyst layer. The perpendicularly aligned CNT is formed on the substrate 12 using a chemical vapor deposition (CVD) method. In this embodiment, silicon is used as a material of the substrate 12, but the material is not limited to silicon, and another material suitable for depositing CNT substantially perpendicularly on the substrate 12, such as stainless steel or aluminum, may be used instead. Note that the perpendicularly aligned CNT may be generated by aligning a single CNT generated using an arc discharge method, a laser deposition method, or a vapor phase fluidization method perpendicularly on the substrate.

Note that in this embodiment, Pt (the Pt particles 16) is used as the catalyst, but one or more types of various metals, such as rhodium, palladium, iridium, osmium, ruthenium, rhenium, gold, silver, nickel, cobalt, lithium, lanthanum, strontium, and yttrium, may be used instead. An alloy formed by combining two or more of these metals may also be used. Further, an identical polymer resin (Nafion) to the electrolyte membrane 20 is used as the electrolyte resin 18, but a different polymer resin to the electrolyte membrane 20 may be used.

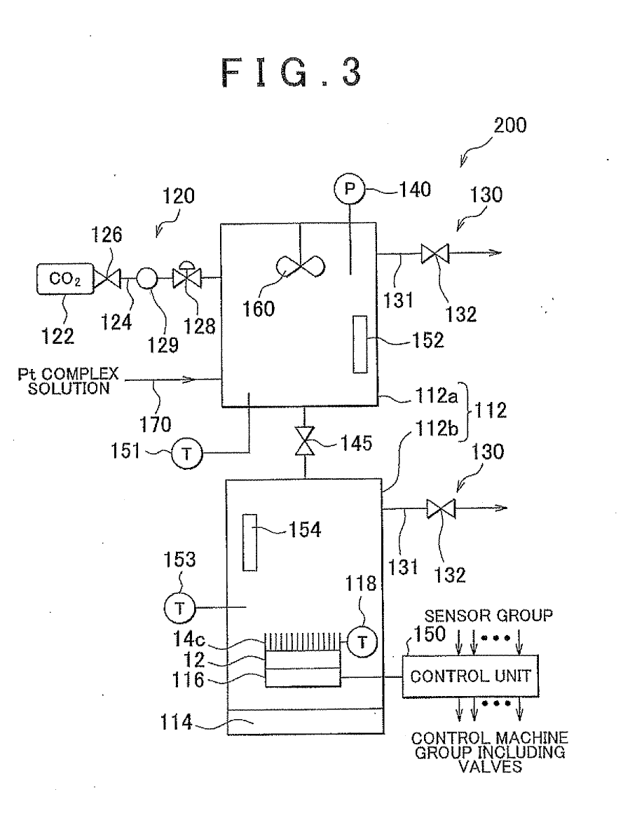

Next, a method of manufacturing the electrode catalyst layer 10 will be described. FIG. 3 is a schematic view showing a manufacturing apparatus for the electrode catalyst layer 10. An electrode catalyst layer manufacturing apparatus 200 includes a reactor 112, a carbon dioxide (CO₂) supply system 120, a carbon dioxide discharge system 130, a pressure gauge 140, and a control unit 150. The reactor 112 includes a reactor first container 112a and a reactor second container 112b forming two tightly sealed containers, the respective containers being filled with carbon dioxide and sealed. The control unit 150 is constituted by a computer having a CPU for performing logic operations and so on, and is used to control a compressor, a valve, and so on, to be described below, on the basis of detection values from various sensors to be described below and so on.

The reactor first container 112a is a container for dispersing (dissolving) a Pt complex solution, to be described below, through supercritical carbon dioxide to manufacture Pt complex-dispersed supercritical carbon dioxide. The reactor first container 112a of the electrode catalyst layer manufacturing apparatus 200 includes a pressure gauge 140, an internal temperature sensor 151, a heater 152, and a stirring propeller 160. The control unit 150 controls an internal temperature of the reactor first container 112a, or in other words a temperature of the supercritical carbon dioxide, during a catalyst carrying process to be described below by controlling the heater 152 on the basis of a reactor internal temperature detected by the internal temperature sensor 151. The stirring propeller 160 stirs a fluid (the supercritical carbon dioxide) in the reactor first container 112a. In the electrode catalyst layer manufacturing apparatus 200, the carbon dioxide supply system 120, the carbon dioxide discharge system 130, and a solution introduction passage 170 for introducing the Pt complex solution are connected to the reactor first container 112a.

The reactor second container 112b is a container for bringing the Pt complex-dispersed supercritical carbon dioxide into contact with the CNT 14 so that the Pt serving as the catalyst is carried on the CNT 14. The reactor second container 112b is tightly sealed by a lid portion 114. The reactor second container 112b of the electrode catalyst layer manufacturing apparatus 200 includes a heating device 116, a temperature sensor 118, an internal temperature sensor 153, and a heater 154. The control unit 150 controls an internal temperature of the reactor second container 112b, or in other words the temperature of the supercritical carbon dioxide when the Pt is carried, during the catalyst carrying process to be described below by controlling the heater 154 on the basis of a reactor internal temperature detected by the internal temperature sensor 153.

During Pt carrying and formation of the electrolyte resin membrane, the substrate 12 is set on the heating device 116, and by heating the set substrate 12, the CNT 14 formed on the substrate is heated. The control unit 150 controls the heating device 116 on the basis of the temperature of the CNT 14, detected by the temperature sensor 118, so that the CNT 14 reaches a predetermined temperature when the Pt is carried. In this case, the temperature of the CNT 14 formed on the substrate 12 is dependent on the temperature of the heated substrate 12, and therefore the CNT 14 can be set at the predetermined temperature when the Pt is carried by detecting the temperature of the substrate 12 using the temperature sensor 118 and controlling the heating device 116 on the basis of the detected temperature. In the electrode catalyst layer manufacturing apparatus 200, the carbon dioxide discharge system 130 is connected to the reactor second container 112b, and the reactor first container 112a is connected to the reactor second container 112b via a shutoff valve 145. When the shutoff valve 145 is opened, the Pt complex-dispersed supercritical carbon dioxide manufactured in the reactor first container 112a flows into the reactor second container 112b. Note that the reactor second container 112b may be set in a vacuum condition using a suction machine, not shown in the drawings, connected to the carbon dioxide discharge system 130.

The carbon dioxide supply system 120 includes a carbon dioxide tank 122, a carbon dioxide gas supply passage 124, a pressure regulating valve 128 provided in the gas supply passage, and a compressor 129. The carbon dioxide tank 122 includes a shutoff valve 126, and by opening and closing the shutoff valve 126, carbon dioxide gas is supplied and stopped.

The carbon dioxide gas stored in the carbon dioxide tank 122 is discharged into the carbon dioxide gas supply passage 124 connected to the carbon dioxide tank 122, pressurized by the compressor 129, subjected to pressure regulation by the pressure regulating valve 128, and then supplied to the reactor first container 112a. A pressurization condition of the compressor 129 and the valve driving conditions described above are controlled by the control unit 150.

The carbon dioxide discharge system 130 includes a carbon dioxide gas exhaust passage 131 and an exhaust valve 132 provided in the gas exhaust passage. As will be described below, by opening the exhaust valve 132 after forming the electrode catalyst layer 10 on the substrate 12, the carbon dioxide in the reactor first container 112a is discharged from the reactor first container 112a in the form of carbon dioxide gas. A similar operation is performed in the reactor second container 112b.

In this embodiment, when carbon dioxide gas is charged into the reactor first container 112a initially, the carbon dioxide gas is introduced into the reactor first container 112a and the exhaust valve 132 is opened to replace air in the reactor first container 112a with the carbon dioxide gas.

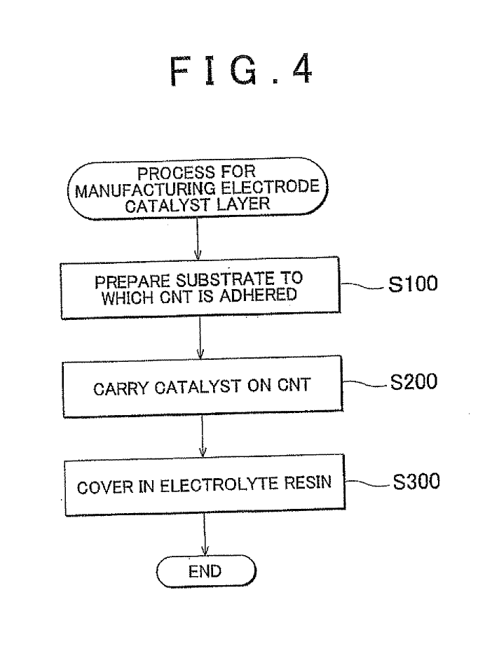

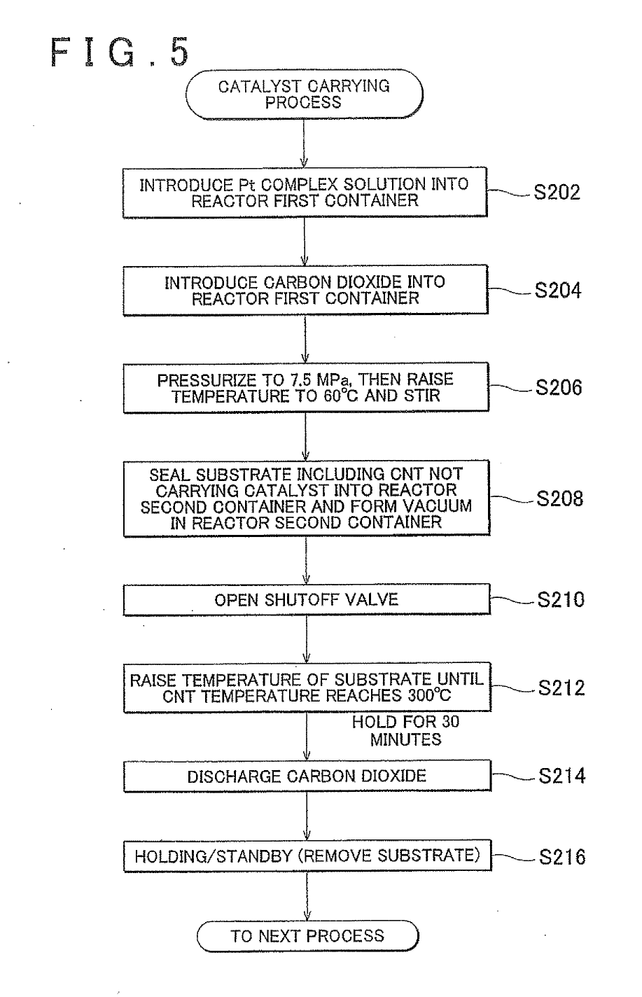

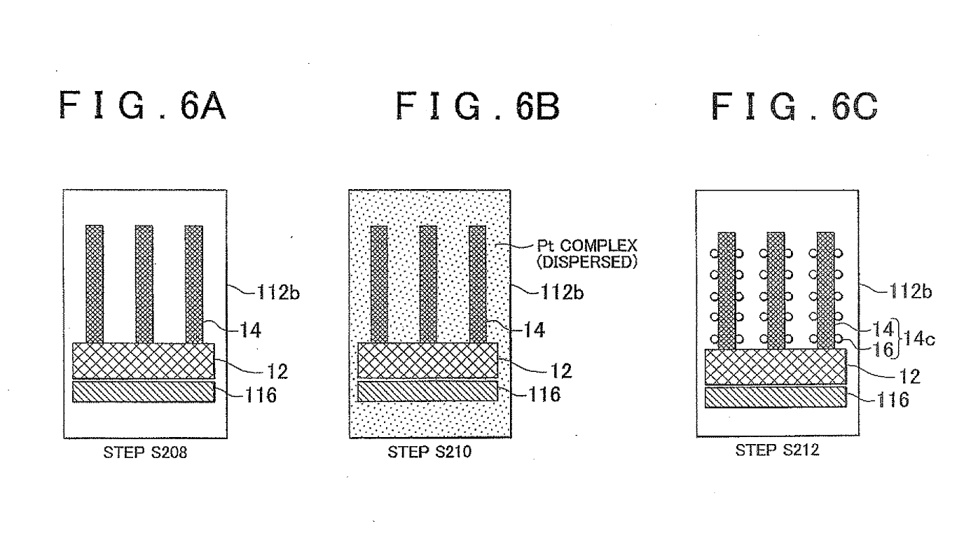

Next, a process for manufacturing the electrode catalyst layer 10 will be described. FIG. 4 is a process diagram showing an overall flow of the process for manufacturing the electrode catalyst layer. FIG. 5 is a process diagram showing the catalyst carrying process in detail. FIGS. 6A to 6C are schematic views illustrating the catalyst carrying process.

As shown in FIG. 4, to obtain the electrode catalyst layer 10, a process (Step S100) for preparing the substrate 12 on which the CNT 14 is aligned substantially perpendicularly and adhered to a substrate surface, a process (Step S200) for carrying the Pt particles 16 on a surface of the CNT 14 on the prepared substrate 12 to turn the CNT into the Pt carrying CNT 14c (see FIG. 2), and a process (Step S300) for covering the Pt carrying CNT 14c with the electrolyte resin 18 are performed.

In Step S100, the CNT 14 is formed in a substantially perpendicular alignment on the surface of the substrate 12 using the CVD method, as described above. Alternatively, a single CNT generated using an arc discharge method, a laser deposition method, or a vapor phase fluidization method may be formed in a substantially perpendicular alignment on the surface of the substrate 12. Alternatively, the substrate 12 may be obtained with the CNT 14 already aligned substantially perpendicularly thereon.

As shown in FIG. 5, in the catalyst carrying process of Step S200, first, the Pt complex solution is introduced and sealed into the reactor first container 112a (Step S202). To ensure that the Pt particles 16 are carried on the CNT 14 in this embodiment, methyl-cyclopentadienyl Pt or trimethyl-cyclopentadienyl Pt, which are Pt complexes, is diluted in hexane so that Pt particles are obtained in an amount corresponding to a carrying amount. This dilution is introduced into the reactor first container 112a as the Pt complex solution through the solution introduction passage 170. In this embodiment, the Pt complex solution is introduced at 500 wt % or more relative to the CNT 14 serving as the Pt carrier. Note that the air in the reactor first container 112a is replaced by carbon dioxide gas prior to introduction of the Pt complex solution, as noted above, and therefore the introduced Pt complex solution does not come into contact with air.

Next, carbon dioxide gas is introduced into the reactor first container 112a from the carbon dioxide supply system 120 (Step S204). The carbon dioxide gas in the reactor first container 112a is then pressurized to 7.5 MPa by controlling the compressor 129 during introduction of the carbon dioxide gas, increased to a gas temperature of 60° C. by controlling the heater 152, and stirred by the stirring propeller 160 (Step S206). Carbon dioxide has a critical point of 31.1° C., 7.38 MPa, and therefore, through the temperature increase and pressurization of Step S206, the carbon dioxide in the reactor first container 112a enters a supercritical condition (turns into supercritical carbon dioxide) through which the Pt complex (Pt complex solution) is dispersed. Due to the stirring performed by the stirring propeller 160, the Pt complex solution is dispersed throughout the entire container, and as a result, the reactor first container 112a becomes filled with Pt complex-dispersed supercritical carbon dioxide. The Pt complex-dispersed supercritical carbon dioxide at this time is maintained at the pressure and temperature realized by the regulation of Step S206.

After, or in parallel with, Step S206, the substrate 12 on which the CNT 14 not yet carrying a catalyst is substantially perpendicularly aligned is set on the heating device 116 in the reactor second container 112b, whereupon the reactor second container 112b is tightly sealed by the lid portion 114 so that a vacuum is formed in the reactor second container 112b (Step S208). Thus, the reactor second container 112b is tightly sealed in a vacuum condition with the substrate 12, on which the CNT 14 not yet carrying a catalyst is substantially perpendicularly aligned, provided therein (see FIG. 6A).

Next, in Step S210, the shutoff valve 145 is opened so that the Pt complex-dispersed supercritical carbon dioxide flows into the reactor second container 112b. As a result, as shown in FIG. 6B, the substrate 12 on which the CNT 14 not yet carrying a catalyst is substantially perpendicularly aligned is placed in a sealed environment of Pt complex-dispersed supercritical carbon dioxide inside the reactor second container 112b. In this case, a pressure of the Pt complex-dispersed supercritical carbon dioxide decreases slightly as the supercritical carbon dioxide flows into the vacuum-condition reactor second container 112b. However, the pressure is regulated in advance in Step S206 so that a pressure of 7.5 MPa is obtained after the supercritical carbon dioxide flows into the reactor second container 112b in Step S210. Likewise, a temperature of the Pt complex-dispersed supercritical carbon dioxide falls slightly as the supercritical carbon dioxide flows into the reactor second container 112b, but the temperature is maintained at 60° C. by the heater 154 in the reactor second container 112b.

Hence, the substrate 12 on which the CNT 14 not yet carrying a catalyst is substantially perpendicularly aligned is placed in a sealed environment of Pt complex-dispersed supercritical carbon dioxide inside the reactor second container 112b, and in this sealed environment, the Pt complex-dispersed supercritical carbon dioxide is maintained at a pressure (7.5 MPa) that is approximately 1.6% higher than a supercritical pressure (7.38 MPa) thereof. Further, the Pt complex-dispersed supercritical carbon dioxide is maintained at the aforesaid temperature of 60° C. in the sealed environment, and this temperature (60° C.) is lower than a decomposition temperature (169° C.) of the Pt complex. Note that in this embodiment, a vacuum is established in the reactor second container 112b (Step S208), but carbon dioxide may be charged into the reactor second container 112b such that the pressure thereof is lower than the pressure of the reactor first container 112a. Then, when the shutoff valve 145 is opened in Step S210, the Pt complex-dispersed supercritical carbon dioxide may be caused to flow into the reactor second container 112b by a differential pressure between the containers. Likewise in this case, the pressure and temperature are regulated and maintained as described above.

In Step S212, the temperature of the substrate 12 is raised by the heating device 116 until the temperature of the CNT 14 reaches 300° C., whereupon the temperature of the CNT 14 is held at 300° C. for 30 minutes. Hence, during this period, the temperature of the CNT 14 not yet carrying a catalyst is maintained at a higher temperature (300° C.) than the decomposition temperature (169° C.) of the Pt complex via the heating implemented on the substrate 12 by the heating device 116, the pressure of the Pt complex-dispersed supercritical carbon dioxide is maintained at 7.5 MPa, which is approximately 1.6% higher than the aforementioned supercritical pressure (7.38 MPa), and the temperature of the Pt complex-dispersed supercritical carbon dioxide is maintained at a lower temperature (60° C.) than the decomposition temperature (169° C.) of the Pt complex. In Step S212, the Pt is carried on the CNT 14, and this catalyst carrying process will be described below with reference to the drawings. Note that since the temperature of the CNT 14 is dependent on the temperature of the heated substrate 12, as noted above, the substrate 12 may be maintained at a temperature corresponding to the temperature (300° C.) of the CNT 14 in Step S212. Further, raising the temperature of the substrate 12 using the heating device 116 can be completed before the valve is opened in Step S210. In other words, the temperature of the substrate 12 can be raised in parallel with the processing up to Step S210.

After the shutoff valve 145 is opened in Step S210, the interior of the reactor second container 112b is filled with the Pt complex-dispersed supercritical carbon dioxide, as shown in FIG. 6B, and therefore the substrate 12 is placed in a sealed environment of supercritical carbon dioxide together with the CNT 14. In the reactor second container 112b at this time, the temperature of the supercritical carbon dioxide is lower than the decomposition temperature (169° C.) of the Pt complex, and therefore the Pt complex is dispersed through the supercritical carbon dioxide without decomposing so as to contact the CNT 14 on the substrate 12. The raised temperature (300° C.) of the CNT 14 is higher than the decomposition temperature (approximately 169° C.) of the Pt complex, and therefore the Pt complex dispersed through the supercritical carbon dioxide contacting the CNT 14 decomposes upon reception of the heat of the CNT 14. As a result, the Pt particles 16 serving as the catalyst contained in the Pt complex are carried on the surface of the CNT 14.

In Step S212 following Step S210, the temperature of the CNT 14 is held at 300° C. for 30 minutes, and therefore the Pt particles 16 are gradually carried on the surface of the CNT 14. As a result, as shown in FIG. 6C, the Pt carrying CNT 14c, in which the Pt particles 16 are carried on the surface of the CNT 14, is formed on the surface of the substrate 12 in a substantially perpendicular alignment.

In Step S214, the exhaust valve 132 of the reactor second container 112b is opened to discharge the carbon dioxide from the reactor second container 112b. Next, in Step S216, the reactor second container 112b is held in an atmospheric pressure condition established when the carbon dioxide is discharged, while waiting for the internal temperature of the reactor second container 112b to fall to room temperature. In this case, the reactor second container 112b may be cooled by blowing cold air or the like. Once the reactor second container 112b is cooled, the routine advances to the next process (electrolyte resin covering: FIG. 4/Step S300).

In the electrolyte resin covering process, various methods are employed to cover the Pt carrying CNT 14c in electrolyte resin (Nafion) using the substrate 12 on which the Pt carrying CNT 14c, obtained in the catalyst carrying process described above, is aligned substantially perpendicularly. For example, the Pt carrying CNT 14c is covered in Nafion (the electrolyte resin 18 of FIG. 2) by dripping a Nafion solution obtained by dissolving Nafion into alcohol onto the Pt carrying CNT 14c on the substrate 12 and then drying the Nafion solution. Alternatively, a supercritical fluid, for example supercritical trifluoromethane, through which a Nafion solution is dispersed is created in the reactor first container 112a using an apparatus having a similar constitution to the electrode catalyst layer manufacturing apparatus 200 shown in FIG. 3, whereupon the Nafion solution-dispersed supercritical trifluoromethane is caused to flow into the reactor second container 112b such that the substrate 12 on which the Pt carrying CNT 14c is substantially perpendicularly aligned is placed in a sealed environment of Nafion solution-dispersed supercritical trifluoromethane. The Nafion dispersed through the supercritical trifluoromethane is then deposited on the Pt carrying CNT 14c in the sealed environment by controlling the pressure and temperature of the supercritical trifluoromethane and cooling the substrate in order to cool the Pt carrying CNT 14c. As a result, the Pt carrying CNT 14c is covered in Nafion (the electrolyte resin 18 of FIG. 2). Thus, the electrode catalyst layer 10 is formed on the surface of the substrate 12.

The MEA 30 is obtained by transferring the electrode catalyst layer 10 obtained in the manner described above onto the respective surfaces of the electrolyte membrane 20. Then, by forming the sealing member 32 on the outer periphery of the MEA 30 as described above, the integrated sealing member type MEA 300 can be manufactured. The fuel cell 100 can then be manufactured by laminating the gas diffusion layers and so on described above onto the anode side and cathode side of the integrated sealing member type MEA 300.

With the manufacturing method for the electrode catalyst layer 10 according to this embodiment, as described above, the substrate 12 on which the CNT 14 not yet carrying the Pt particles 16 serving as the catalyst is aligned substantially perpendicularly is placed in a sealed environment of Pt complex-dispersed supercritical carbon dioxide in the reactor second container 112b, whereupon the temperature of the supercritical carbon dioxide in this sealed environment is maintained below the decomposition temperature of the Pt complex (Steps S206 to S212). As a result, the Pt complex is dispersed through the supercritical carbon dioxide in the reactor second container 112b without decomposing. As regards the CNT 14 (not yet carrying the Pt) adhered to the substrate 12, the temperature of the substrate 12 is maintained at or above the decomposition temperature of the Pt complex by heating the substrate 12 (Step S212), and therefore the Pt complex dispersed through the supercritical carbon dioxide that contacts the CNT 14 aligned substantially perpendicularly on the substrate 12 decomposes on the surface of the CNT 14 not yet carrying the Pt. The Pt complex is thereby deposited on the surface of the CNT 14, and as a result, the Pt catalyst is carried on the CNT 14. Thus, the Pt carrying CNT 14c carrying the Pt catalyst can be obtained in a substantially perpendicular alignment on the substrate 12.

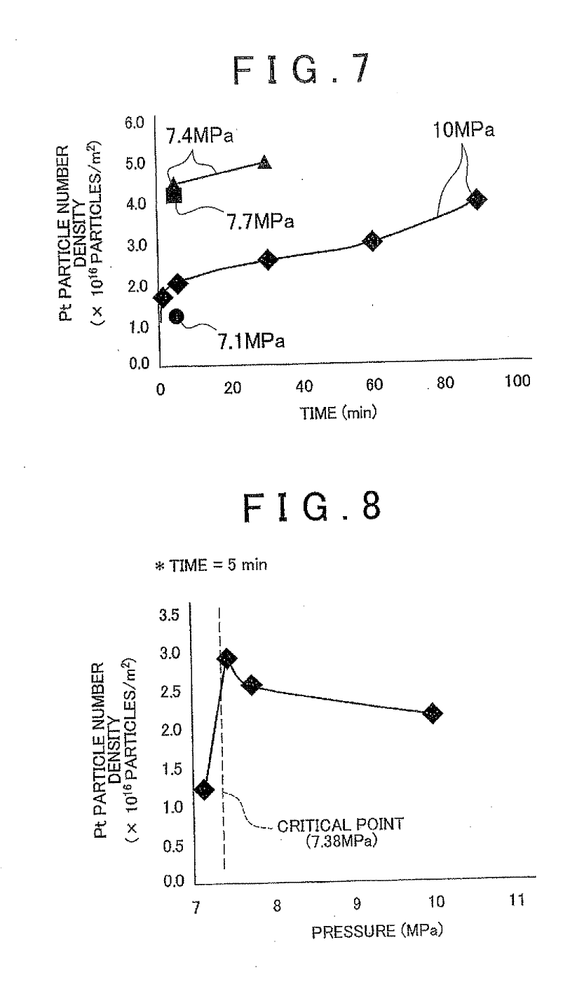

Furthermore, according to this embodiment, the pressure of the supercritical carbon dioxide in the sealed environment of supercritical carbon dioxide where carrying of the Pt catalyst occurs is maintained at 7.5 MPa, which is approximately 1.6% higher than the supercritical pressure (7.38 MPa) of carbon dioxide. Here, the pressure and the Pt carrying process will be described. FIG. 7 is a graph showing a relationship between the pressure and a carried particle density of the Pt particles in a case where a predetermined amount of the Pt complex is dispersed through the supercritical carbon dioxide. The respective pressure values shown on the graph indicate the pressure of the supercritical carbon dioxide in Step S212 following regulation in Step S206. A Pt carrying density (Pt particle number density) on the ordinate was measured using an electron microscope. Further, the results shown in FIG. 7 were obtained in a case where the temperature of the CNT 14 formed on the substrate 12 was set at 300° C., thereby exceeding the decomposition temperature (169° C.) of the Pt complex, by setting the substrate 12 at approximately 300° C. using the heating device 116 in Step S212.

As shown in the drawing, at a lower pressure (7.1 MPa) than the critical pressure (7.38 MPa) of carbon dioxide, the Pt carrying density was determined to be low. A reason for this may be that since the carbon dioxide does not shift toward a supercritical condition, dispersion of the Pt complex does not advance.

At a pressure of 10 MPa, which is greater than the critical pressure (approximately 35% greater than the supercritical pressure 7.38 MPa of carbon dioxide), a Pt carrying speed was comparatively sluggish, but by making a carrying time (the holding time of Step S212) comparatively long, a high Pt carrying density was obtained. When a comparatively short holding time (30 minutes) was employed in this case, it was possible to obtain a Pt carrying density approximately twice that obtained at the low pressure (7.1 MPa) prior to the supercritical transition.

At a slightly higher pressure (7.4 MPa, 7.7 MPa) than the critical pressure (7.38 MPa), a high Pt carrying density approximately four to five times greater than that obtained at the low pressure (7.1 MPa) prior to the supercritical transition was obtained even with a very short carrying time of approximately several minutes, and with the holding time of 30 minutes, the Pt carrying density increased even further. Hence, the carrying speed and carrying density at which Pt carrying occurs in a sealed environment of supercritical carbon dioxide is heavily dependent on the pressure of the sealed environment (the pressure of the supercritical carbon dioxide) such that when the supercritical carbon dioxide pressure is too high, the efficiency of Pt carrying does not improve, but when the supercritical carbon dioxide pressure is set at a pressure slightly exceeding the critical pressure, the effectiveness of Pt carrying is improved. In this case, costs can be reduced by making the holding time as short as possible, but to ensure that the catalyst is carried effectively, a holding time of approximately 20 to 30 minutes may be employed without practical problems.

FIG. 8 is a graph showing a relationship between the pressure and the carried particle density of the Pt particles in a case where the predetermined amount of the Pt complex is dispersed through the supercritical carbon dioxide and catalyst carrying is performed for only five minutes. It is likewise evident from FIG. 8 that the carrying density obtained during Pt carrying in a sealed environment of supercritical carbon dioxide is dependent on the pressure of the sealed environment (the pressure of the supercritical carbon dioxide) such that a high Pt carrying density is obtained in a pressure range slightly above the critical pressure (7.38 MPa) and the density decreases as the pressure rises. Therefore, in this embodiment, the pressure of the supercritical carbon dioxide in the sealed environment of supercritical carbon dioxide where carrying of the Pt catalyst occurs is maintained at 7.5 MPa, which is approximately 1.6% higher than the supercritical pressure (7.38 MPa) of carbon dioxide. According to this embodiment, by maintaining the pressure and maintaining the temperature in the manner described above, the Pt carrying CNT 14c (see FIG. 2) in which the Pt particles 16 are carried on the surface of the CNT 14 can be obtained highly effectively. As a result, Pt carrying can be performed in a short amount of time, leading to an improvement in the manufacturing efficiency of the Pt carrying CNT 14c, and accordingly the electrode catalyst layer 10, and a corresponding reduction in cost.

When carbon dioxide is used as the supercritical fluid and the Pt complex is dispersed through the supercritical carbon dioxide, as described above, the pressure of the supercritical carbon dioxide can be maintained at a pressure that is at least 1% higher than the supercritical pressure (7.38 MPa) of carbon dioxide. For example, the pressure of the supercritical carbon dioxide can be maintained at a pressure within a range of 1 to 2% higher than the supercritical pressure (7.38 MPa) of carbon dioxide. In other words, as long as the pressure of the supercritical carbon dioxide equals or exceeds the supercritical pressure (7.38 MPa) of carbon dioxide, the range in which the pressure of the supercritical carbon dioxide is maintained may be determined through experiment, taking into account the types, properties, and so on of the carbon dioxide serving as the supercritical fluid and the catalyst complex (Pt complex). For example, as long as a holding time of approximately 20 to 30 minutes is secured, as described above, the pressure of the supercritical carbon dioxide may be set at 10 MPa, which is approximately 35% higher than the supercritical pressure (7.38 MPa) of carbon dioxide. Note that the Pt carrying density (Pt particle number density) on the ordinate of FIG. 8 was measured using an electron microscope, similarly to FIG. 7. Further, similarly to FIG. 7, the results shown in FIG. 8 were obtained in a case where the temperature of the substrate 12 was set at approximately 300° C. using the heating device 116.

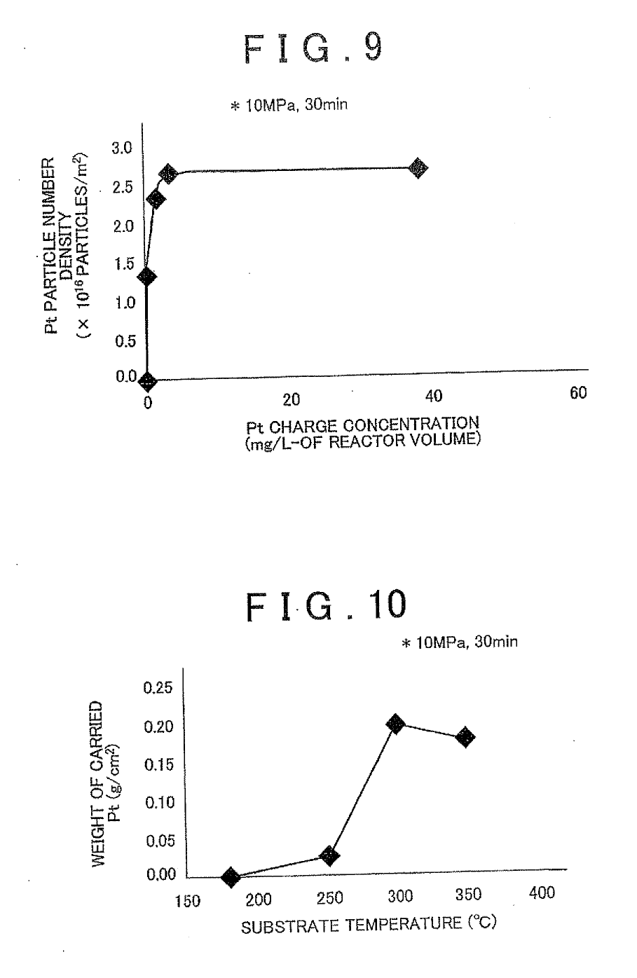

Next, relationships to the Pt complex dispersion will be described. FIG. 9 is a graph showing a relationship between the carried particle density of the Pt particles and an amount of a Pt complex solution introduced into the reactor second container 112b. On this graph, the abscissa shows a weight (a Pt charge concentration) of the Pt complex solution per 1 liter (1 L) volume of the reactor second container 112b, obtained when catalyst carrying was performed for 30 minutes at a supercritical carbon dioxide pressure of 10 MPa. The Pt carrying density (Pt particle number density) on the ordinate was measured using an electron microscope, similarly to FIG. 7, and the results shown in FIG. 9, similarly to FIG. 7, were obtained in a case where the temperature of the substrate 12 was set at approximately 300° C. using the heating device 116. It is evident from FIG. 9 that when the weight of the Pt complex solution is increased, the Pt carrying density does not increase in accordance with the weight increase, and therefore the required Pt carrying density is obtained by introducing the Pt complex solution into the reactor second container 112b at a weight of 5 to 20 mg/L. On the graph in FIG. 9, the pressure of the supercritical carbon dioxide is set at 10 MPa, but an identical tendency is exhibited when the pressure of the supercritical carbon dioxide is set at 7.5 MPa, and in this case also, the Pt complex solution is preferably introduced into the reactor second container 112b at a weight of 5 to 20 mg/L. Note that the weight of the Pt complex solution sealed into the reactor second container 112b may be determined appropriately through experiment in accordance with a carried weight of the Pt catalyst carried on the CNT 14, a substrate size of the substrate 12 to which the CNT 14 is adhered, or more specifically the amount of CNT 14 adhered to the substrate 12, an internal volume of the reactor second container 112b, and so on.

A relationship between the degree of carrying of the Pt particles and the temperature of the CNT 14 will now be described with respect to a course of the temperature of the substrate 12. FIG. 10 is a graph showing a relationship between the carried weight of the Pt particles and the substrate temperature defining the carrier (CNT 14) temperature in the reactor second container 112b. On this graph, the abscissa shows the temperature of the substrate 12 defining the temperature of the CNT 14 formed on the substrate 12, and the ordinate shows the carried weight of the Pt particles per unit surface area of the CNT 14 formed on the substrate 12, these results having been obtained when catalyst carrying was performed for 30 minutes at a supercritical carbon dioxide pressure of 10 MPa. The carried weight was determined from a difference between a weight of the substrate 12 prior to catalyst carrying and the CNT 14 formed thereon and a weight of the substrate 12 following catalyst carrying (after executing Step S212) and the CNT 14 formed thereon.

According to this embodiment, when the CNT 14 formed on the substrate 12 is set at the decomposition temperature (169° C.) of the Pt complex during execution of Step S212, the substrate 12 must be heated to approximately 250° C. by the heating device 116 in the reactor second container 112b. In other words, to set the temperature of the CNT 14 formed on the substrate 12 at 300° C., exceeding the decomposition temperature (169° C.) of the Pt complex, the substrate 12 must be heated to at least 300° C. by the heating device 116 in the reactor second container 112b. In this case, the substrate temperature is set in accordance with the internal volume of the reactor second container 112b, the size of the substrate 12, and so on. It is evident from the course of the carried particle density of the Pt particles in FIG. 10 that in order to set the temperature of the CNT 14 formed on the substrate 12 at or above 300° C., exceeding the decomposition temperature (169° C.) of the Pt complex, the temperature of the substrate 12 defining the temperature of the CNT 14 formed on the substrate 12 is preferably maintained within a temperature range of 300 to 350° C. In other words, to ensure that the catalyst is carried effectively in the employed reactor second container 112b, the temperature of the substrate 12, which defines the temperature of the CNT 14 formed on the substrate 12, is preferably maintained by the heating device 116 within a temperature range of 300 to 350° C.

Although the temperature of the substrate 12 is preferably set at or above 300° C., it has been determined that as the temperature of the substrate 12 increases, the Pt particles are carried on components other than the CNT 14, for example inside walls of the reactor container on the periphery of the heating device 116 and so on, and therefore the substrate 12 is preferably maintained within the aforesaid temperature range. Note that on the graph in FIG. 10, the pressure of the supercritical carbon dioxide is set at 10 MPa, but an identical tendency is exhibited when the pressure of the supercritical carbon dioxide is set at 7.5 MPa, and in this case also, the substrate 12 is preferably maintained by the heating device 116 within a temperature range of 300 to 350° C.

Further, in the manufacturing method for the electrode catalyst layer 10 according to this embodiment, the CNT 14 aligned substantially perpendicularly to the substrate 12 is used as the carrier for the Pt particles 16, and therefore the CNT 14 carrying the Pt particles 16 (the Pt carrying CNT 14c) can be obtained in a substantially perpendicular alignment on the substrate 12. Hence, when the Pt carrying CNT 14c is subsequently covered by the electrolyte resin 18, the electrode catalyst layer 10 in which the Pt carrying CNT 14c is covered in the electrolyte resin 18 can be formed on the substrate 12 easily.

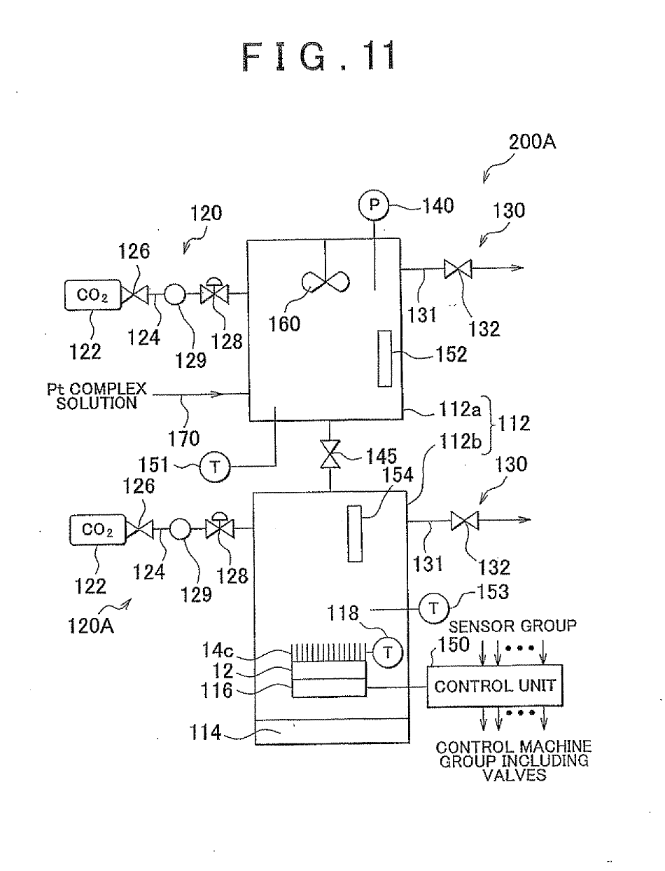

Next, a modified example will be described. In this modified example, the carbon dioxide in the reactor second container 112b, in which the substrate 12 formed with the CNT 14 is sealed, is set in a supercritical condition prior to the catalyst carrying process. FIG. 11 is a schematic view showing a manufacturing apparatus for the electrode catalyst layer 10 according to a modified example. As shown in the drawing, in an electrode catalyst layer manufacturing apparatus 200A according to this modified example, a carbon dioxide supply system 120A is also provided for the reactor second container 112b so that the carbon dioxide in the reactor second container 112b can be set in a supercritical condition separately to the reactor first container 112a. Constitutions of all other machines are similar to those of the embodiment described above.

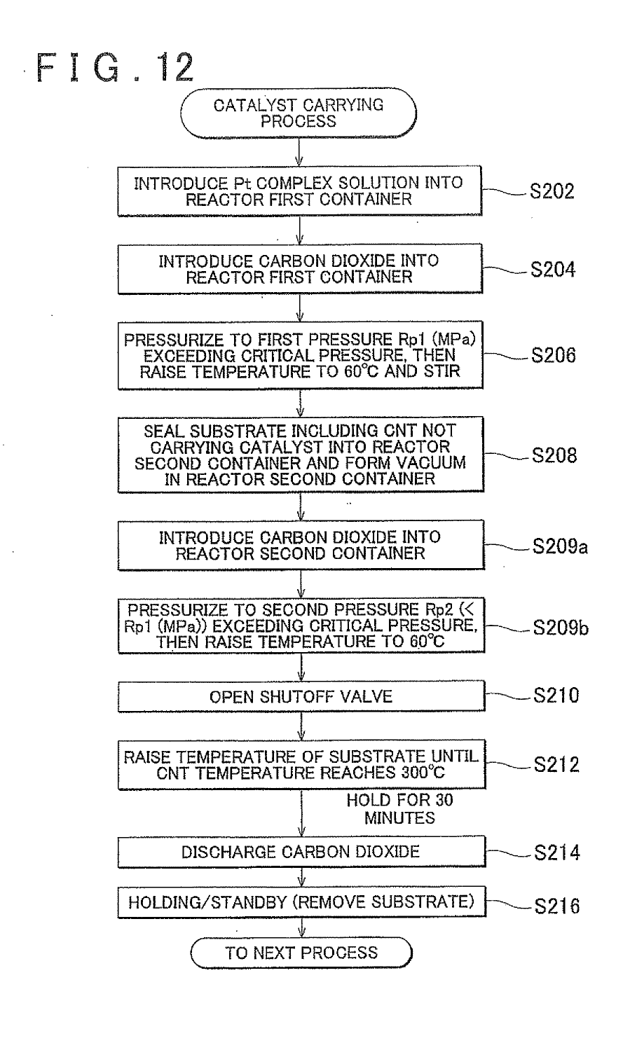

Next, a process for manufacturing the electrode catalyst layer 10 using the electrode catalyst layer manufacturing apparatus 200A shown in FIG. 11 will be described. FIG. 12 is a process diagram showing a catalyst carrying process according to this modified example in detail.

In the catalyst carrying process according to this modified example, similarly to the process of the embodiment described above, the substrate 12 on which the CNT 14 is formed in a substantially perpendicular alignment is prepared, the Pt complex solution is introduced and sealed into the reactor first container 112a (Step S202), carbon dioxide gas is introduced into the reactor first container 112a from the carbon dioxide supply system 120 (Step S204), and the carbon dioxide in the reactor first container 112a is set in a supercritical condition (turned into supercritical carbon dioxide) in Step S206. In the modified example at this time, the carbon dioxide in the reactor first container 112a is set at a first pressure Rp1 (MPa), for example 11 MPa, which exceeds the supercritical pressure (7.38 MPa), by controlling the compressor 129, while the temperature is set at 60° C., which is lower than the decomposition temperature of the Pt complex (Pt complex solution), by controlling the heater 152, as described above. In Step S208 following Step S206, similarly to the embodiment described above, the substrate 12 on which the CNT 14 not yet carrying a catalyst is aligned substantially perpendicularly is set in the reactor second container 112b, whereupon the container is tightly sealed and a vacuum is established therein.

In this modified example, following Step S208, carbon dioxide is introduced into the reactor second container 112b and set in a supercritical condition. More specifically, in Step S209a following Step S208, carbon dioxide gas is introduced into the reactor second container 112b from the carbon dioxide supply system 120A of the reactor second container 112b, and in a following Step S209b, the carbon dioxide in the reactor second container 112b is set at a second pressure Rp2 (MPa), for example 9 MPa), which exceeds the supercritical pressure (7.38 MPa) thereof but is lower than the first pressure Rp1 of Step S206, by controlling the compressor 129. The temperature, meanwhile, is set at 60° C., which is lower than the decomposition temperature of the Pt complex (Pt complex solution), by controlling the heater 154. By setting the gas pressure (the second pressure Rp2) of Step S209b to be lower than the first pressure Rp1 of Step S206 in this manner, a differential pressure used to introduce gas in Step S210, to be described below, is secured. In this case, gas introduction is not impaired as long as a differential pressure of approximately 1 to 2 MPa can be secured, and therefore the first pressure Rp1 of Step S206 and the second pressure Rp2 of Step S209b are preferably determined to achieve this differential pressure range. The pressure following gas introduction will be described below.

Next, in Step S210, similarly to the embodiment described above, the shutoff valve 145 is opened, whereupon the substrate temperature is raised and maintained in Step S212, the carbon dioxide is discharged in Step S214, and holding/standby is performed in Step S216, in that order. The routine then advances to the electrolyte resin covering process (FIG. 4/Step S300). According to this modified example, when the shutoff valve 145 is opened in Step S210, the Pt complex-dispersed supercritical carbon dioxide in the reactor first container 112a flows from the reactor first container 112a into the reactor second container 112b on the basis of the differential pressure between the gas pressure (the second pressure Rp2) of Step S209b and the first pressure Rp1 of Step S206. In this case, the interior of the reactor second container 112b is already filled with supercritical carbon dioxide following Step S209b, and therefore the Pt complex-dispersed supercritical carbon dioxide that flows into the reactor second container 112b from the reactor first container 112a remains in a supercritical condition. In this case, the Pt complex-dispersed supercritical carbon dioxide flows into the reactor second container 112b at the first pressure Rp1 (11 MPa, for example, as noted above), which is higher than the second pressure Rp2 (9 MPa, for example, as noted above) prior to gas introduction, and although a slight pressure reduction occurs at this time, the reduced pressure remains at approximately 10 MPa, for example, which is still higher than the second pressure Rp2 prior to gas introduction. At this pressure, the supercritical condition of the carbon dioxide does not vary. The manner in which catalyst carrying occurs after the Pt complex-dispersed supercritical carbon dioxide has been thus introduced into the reactor second container 112b is as described with reference to FIGS. 6B and 6C. Note that in Step S212 of this modified example, raising the temperature of the substrate 12 using the heating device 116 can be completed before the valve is opened in Step S210, or in other words, the temperature of the substrate 12 can be raised in parallel with the processing up to Step S210, as described above. Further, the first pressure Rp1 and the second pressure Rp2 may be set variously as long as the aforesaid differential pressure can be secured such that the pressure following gas introduction does not cause variation in the supercritical condition of the carbon dioxide.

In this modified example also, the pressure of the Pt complex-dispersed supercritical carbon dioxide decreases when the valve is opened in Step S210. However, the pressure reduction is within the aforesaid differential pressure range, and therefore the pressure of the Pt complex-dispersed supercritical carbon dioxide does not fall below the supercritical point pressure. Further, in this modified example, the substrate 12 on which the CNT 14 not yet carrying a catalyst is aligned substantially perpendicularly is placed in a sealed environment of Pt complex-dispersed supercritical carbon dioxide in the reactor second container 112b, similarly to the embodiment described above, and therefore the effects described above can be obtained. Moreover, the Pt complex-dispersed supercritical carbon dioxide is caused to flow into the reactor second container 112b by the aforesaid differential pressure after filling the reactor second container 112b with supercritical carbon dioxide in advance in Steps S209a and S209b, and therefore, even when the internal volume of the reactor second container 112b is larger than that of the reactor first container 112a, for example, the Pt complex-dispersed supercritical carbon dioxide can be introduced into the reactor second container 112b without undergoing a large pressure reduction. In other words, according to this modified example, mass production of the electrode catalyst layer 10 can be achieved by increasing the size of the reactor second container 112b.

An embodiment of the invention was described above, but the invention is not limited to the above embodiment and may be implemented in various embodiments within a scope that does not depart from the spirit thereof. For example, the following amendments may be implemented.

In the above embodiment, a perpendicularly aligned CNT is cited as an example of a conductive carrier, but various conductive carriers may be used. For example, a perpendicularly aligned carbon nanowall may be used. Further, a perpendicular nanomaterial other than carbon, for example a metal oxide (Nb₂O₃: niobium trioxide; ZnO: zinc oxide), TiN: titanium nitride and TiB: titanium boride may be used. Furthermore, a carbon material such as carbon black, natural graphite powder, artificial graphite powder, or mesocarbon microbeads (MCMB) may be used instead of a perpendicularly aligned carrier. Catalyst carrying can be executed by the reactor 112 in a similar manner to that described above when these conductive carriers are used.

In the above embodiment, catalyst carrying is achieved by varying the temperature of the substrate 12 in order to heat the CNT 14, but the temperatures employed at this time are not limited to the temperatures described in the above embodiment.

Further, in the above embodiment, the CNT 14 carrying the Pt particles 16 (the Pt carrying CNT 14c) is used as the electrode catalyst layer 10 provided on the MEA 30 of the fuel cell 100, but the Pt carrying CNT 14c obtained in the catalyst carrying process of the above embodiment may be used for other applications.

Furthermore, in the above embodiment, supercritical carbon dioxide is used to carry the Pt particles 16, but a supercritical fluid other than carbon dioxide may be used. When a supercritical fluid other than carbon dioxide is used, the pressure of the supercritical fluid in the sealed environment of the supercritical fluid where the catalyst carrying occurs may be determined through experiment, taking into account the types, properties, and so on of the supercritical fluid and the catalyst complex dispersed through the fluid, at a pressure equal to or slightly higher than the supercritical pressure of the fluid.

What is claimed is:

1. A manufacturing method for a conductive catalyst carrier, comprising:
placing a substrate serving as a base material to which a carrier is adhered in a sealed environment of a supercritical fluid through which a catalyst complex is dispersed, and maintaining a temperature of the supercritical fluid below a decomposition temperature of the catalyst complex;
maintaining a temperature of the carrier at or above the decomposition temperature of the catalyst complex by heating the substrate;
maintaining a pressure of the supercritical fluid within a range extending from a supercritical pressure of a fluid used as the supercritical fluid to a pressure at least 1% higher than the supercritical pressure; and
causing the supercritical fluid to contact the carrier so that a catalyst is carried on the carrier.

2. The manufacturing method according to claim 1, wherein the carrier is a perpendicularly aligned material formed substantially perpendicularly on the substrate.

3. The manufacturing method according to claim 2, wherein the perpendicularly aligned material is a perpendicularly aligned carbon nanotube.

4. The manufacturing method according to claim 1, wherein the supercritical fluid is caused to contact the carrier so that the catalyst is carried on the carrier while maintaining the pressure of the supercritical fluid within a range extending from the supercritical pressure of the fluid used as the supercritical fluid to a pressure 1 to 2% higher than the supercritical pressure.
